(19) United States
(12) Patent Application Publication
(10) Pub. No.: US 2006/0095710 A1
(43) Pub. Date: May 4, 2006

(54) Clustered ilp processor and a method for accessing a bus in a clustered ilp processor

(75) Inventors: Orlando Miguel Pires Dos Reis Moreira, Eindhoven (NL); Andrei Terechko, Eindhoven (NL); Victor Martinus Gerardus Van Acht, Eindhoven (NL)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(73) Assignee: KONINKLIJKE PHILIPS ELECTRONICS N.V., EINDHOVEN (NL)

(21) Appl. No.: 10/540,409

(22) PCT Filed: Nov. 28, 2003
(86) PCT No.: PCT/IB03/05584

§ 371 Date: Jun. 24, 2005

(30) Foreign Application Priority Data
Dec. 30, 2002 (EP) 02080588.3

(51) Int. Cl. G06F 15/00

(52) U.S. Cl. 712/15

(57) ABSTRACT

The basic idea of the invention is to add switches along a bus, in order divide the bus into smaller independent segments by opening/closing said switches. A clustered Instruction Level Parallelism processor comprises a plurality of clusters (C1-C6) each comprising at least one register file (RF) and at least one functional unit (FU), a bus means (100) for connecting said clusters (C1-C6), wherein said bus (100) comprises a plurality of bus segments (100a, 100b, 100c), and switching means (200), which is arranged between adjacent bus segments (100a, 100b, 100c). Said switching means (200) are used for connecting or disconnecting adjacent bus segments (100a, 100b, 100c). Furthermore, a method for accessing a bus (100) in a clustered Instruction Level Parallelism processor is shown. Said bus (100) comprises at least one switching means (200) along said bus (100). A cluster can either perform a sending operation based on a source register and transfer word or a receiving operation based on a designation source register and a transfer word. Said switching means are then opened/closed according to said transfer word.

The invention relates to a clustered Instruction Level Parallelism processor and a method for accessing a bus in a clustered Instruction Level Parallelism processor.

One main problem in the area of Instruction Level Parallelism (ILP) processors is the scalability of register file resources. In the past, ILP architectures have been designed around centralised resources to cover for the need of a large number of registers for keeping the results of all parallel operation currently being executed. The usage of a centralised register file eases data sharing between functional units and simplifies register allocation and scheduling. However, the scalability of such a single centralised register is limited, since huge monolithic register files with a large number of ports are hard to build and limit the cycle time of the processor.

Recent developments in the areas of VLSI technologies and computer architectures suggest that a decentralised organisation might be preferable in certain areas. It is predicted that the performance of future processors will be limited by communication restrains rather than computation restrains. One solution to this problem is to portion resources and to physically distribute these resources over the processor to avoid long wires, having a negative effect on communication speed as well as on the latency. This can be achieved by clustering. In a clustered processor several resources, like functional units and register files are distributed over separate clusters. In particular for clustered ILP architectures each cluster comprises a set of functional units and a local register. The main idea behind clustered processors is to allocate those parts of computation, which interact frequently, on the same cluster, whereas those parts which merely communicate rarely or those communication is not critical are allocated on different clusters. However, the problem is how to handle Inter-Cluster-Communication ICC on the hardware level (wires and logic) as well as on the software level (allocating variables to registers and scheduling).

The most widely used ICC scheme is the full point-to-point connectivity topology, i.e. each two clusters have a dedicated wiring allowing the exchange of data. On the one hand, the point-to-point ICC with a full connectivity simplifies the instruction scheduling, but on the other hand the scalability is limited due to the amount of wiring needed: N(N−1), with N being the number of clusters. Accordingly, the quadratic growth of the wiring limits the scalability to 2-10 clusters.

Furthermore, it is also possible to use partially connected networks for point-to-point ICC. Here the clusters are not connected to all other clusters (fully connected) but are e.g. merely connected to adjacent clusters. Although the wiring complexity will be decreased, problems for programming the processor will increase, which are not solved satisfactorily by existing automatic scheduling and allocating tools.

Yet another ICC scheme is the global bus connectivity. The clusters are fully connected to each other via a bus, while requiring much less hardware resources compared to the above full point-to-point connectivity topology ICC scheme. Additionally, this scheme allows a value multicast, i.e. the same value can be send to several clusters at the same time or in other words several clusters can get the same value by reading the bus at the same time. The scheme is furthermore based on statical scheduling, hence neither an arbiter nor any control signals are necessary. Since the bus constitutes a shared resource it is only possible to perform one transfer per cycle limiting the communication bandwidth as being very low. Moreover, the latency of the ICC will increase due to the propagation delay of the bus. The latency will further increase with increasing numbers of clusters limiting the scalability of the processor with such an ICC scheme.

The problem with the limited communication bandwidth can be partially overcome by using a multi-bus, where two busses are used for the ICC instead of one. Although this will increase the communication bandwidth, it will also increase the hardware overhead without decreasing the latency of the bus.

In another ICC communication scheme local busses are used. This ICC scheme is a partially connected communication scheme. Therefore, the local busses merely connect a certain amount of clusters but not all at one time. The disadvantage of this scheme is that it is harder to program, since e.g. if a value is to be send between clusters connected to different local buses, it can not be directly send within one cycle but at least two cycles are needed.

Accordingly, the advantages and disadvantages of the known ICC schemes can be summarised as follows. The point-to-point topology has a high bandwidth but the complexity of the wiring increases with the square of the number of clusters. A multicast, i.e. sending a value to several other clusters, is not possible. On the other hand, the bus topology has a lower complexity, since the complexity linearly increases with the number of clusters, and allows multicast, but has a lower bandwidth. The ICC schemes can either be fully-connected or partially connected. A fully-connected scheme has a higher bandwidth and a lower software complexity, but a higher wiring complexity is present and it is less scalable. A partially-connected scheme units good scalability with lower hardware complexity but has a lower bandwidth and a higher software complexity.

It is therefore an object of the invention to improve the bandwidth of a bus within an ICC scheme for a clustered ILP processor, while decreasing the latency of said bus and without unduly increasing the complexity of the underlying programming system.

This problem is solved by a ILP processor according to claim 1 and a method for accessing a bus in a clustered Instruction Level Parallelism processor according to claim 5.

The basic idea of the invention is to add switches along the bus, in order divide the bus into smaller independent segments by opening/closing said switches.

According to the invention, a clustered Instruction Level Parallelism processor comprises a plurality of clusters C1-C4, a bus means 100 with a plurality of bus segments 100a, 100b, 100c, and switching means 200a, 200b arranged between adjacent bus segments 100a, 100b, 100c. Said bus means 100 is used for connecting said clusters C1-C4, which comprises each at least one register file RF and at least one functional unit FU. Said switching means 200 are used for connecting or disconnecting adjacent bus segments 100a, 100b, 100c.

By splitting the bus into different segments the latency of the bus within one bus segment is improved. Although the overall latency of the total bus, i.e. all switches closed, is nonetheless linearly increasing with the number of clusters, data moves between local or adjacent clusters can have lower latencies than moves over different bus segment, i.e. over different switches. A slow down of local communication, i.e. between neighbouring clusters, due to global interconnect requirements of the bus ICC can be avoided by opening switches, so that shorter busses, i.e. bus segments, with lower latencies can be achieved. Furthermore, incorporating the switches is cheap and easy to implement, while increasing the available bandwidth of the bus and enhancing latency problems caused by a long bus without giving up a fully-connected ICC.

According to an aspect of the invention, said bus means 100 is a multi-bus comprising at least two busses, which will increase the communication bandwidth

The invention also relates to a method for accessing a bus 100 in a clustered Instruction Level Parallelism processor. Said bus 100 comprises at least one switching means 200 along said bus 100. A cluster C1-C4 can either perform a sending operation based on a source register and a transfer word or a receiving operation based on a designation source register and a transfer word. Said switching means 200 are then opened/closed according to said transfer word.

From a software viewpoint, the scheduling of a split or segmented bus is not much more complex than a global bus ICC while merely a few logic gates are needed to control a switch.

According to a further aspect of the invention, said transfer word represents the sending direction for the sending operation and the receiving direction for the receiving operation, allowing the control of the switches according to the direction of a data move.

The invention will now be described in more detail with reference to the drawing, in which:

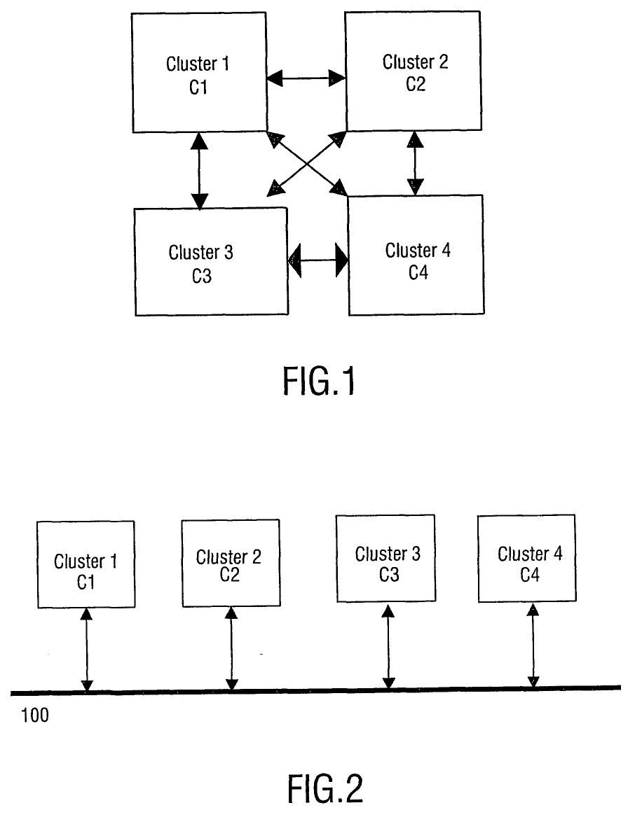

FIG. 1 shows an point-to-point inter-cluster communication ICC scheme;

FIG. 2 shows an ICC scheme via a bus;

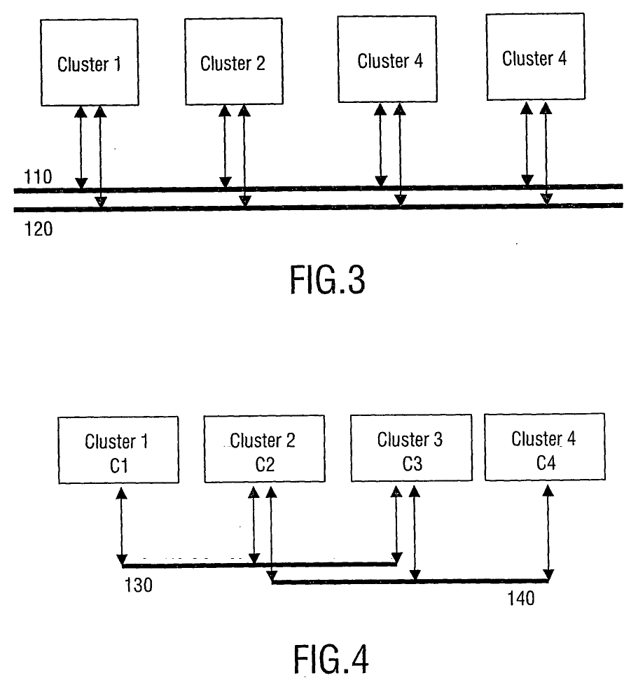

FIG. 3 shows an ICC scheme via a multi-bus;

FIG. 4 shows an ICC scheme via local busses;

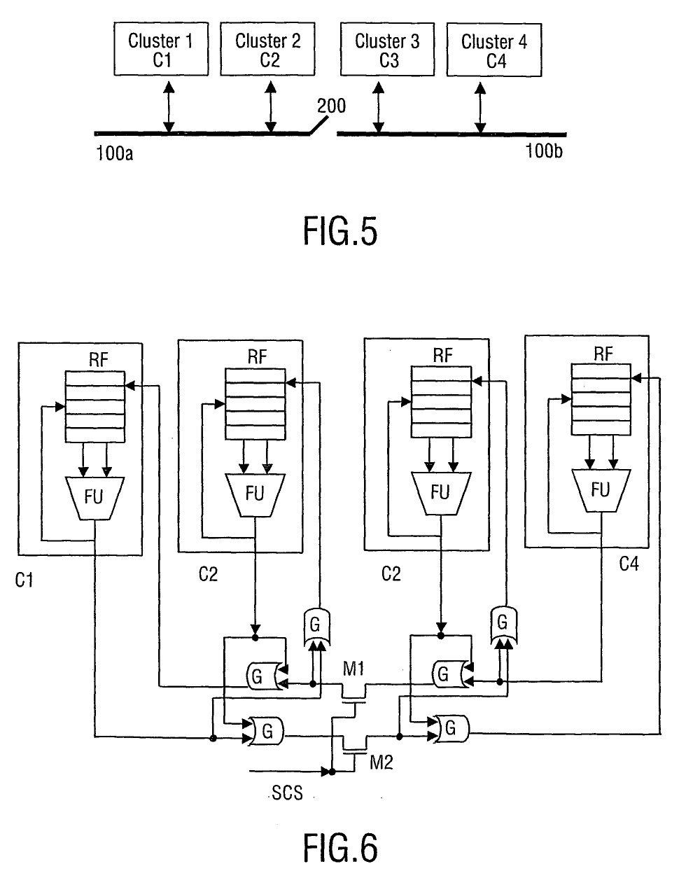

FIG. 5 shows an ICC scheme via a segmented bus according to a first embodiment;

FIG. 6 shows an ICC scheme via a segmented bus according to a second embodiment; and

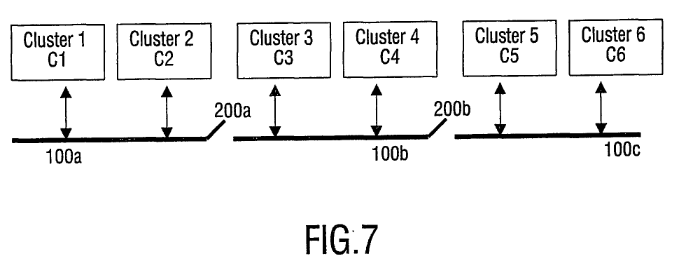

FIG. 7 shows an ICC scheme via a segmented bus according to a third embodiment.

The most widely used ICC scheme is the full point-to-point connectivity topology, i.e. each two clusters have a dedicated wiring allowing the exchange of data. A typical ILP processor with four clusters is shown in FIG. 1.

FIG. 2 shows another ICC scheme with a global bus connectivity. The clusters are fully connected to each other via a bus, while requiring much less hardware resources compared to the ICC scheme as shown in FIG. 1. Additionally, this scheme allows a value multicast, i.e. the same value can be send to several clusters at the same time or in other words several clusters can get the same value by reading the bus at the same time.

The problem with the limited communication bandwidth can be partially overcome by using a multi-bus as shown in FIG. 3, where two busses are used for the ICC instead of one. Although this will increase the communication bandwidth, it will also increase the hardware overhead without decreasing the latency of the bus.

FIG. 4 shows another ICC communication scheme using local busses. This ICC scheme is a partially connected communication scheme. Therefore, the local busses merely connect a certain amount of clusters but not all at one time, e.g. clusters 1 to 3 are connected to one local bus and clusters 2 to 4 are connected to a second local bus. The disadvantage of this scheme is that it is harder to program, since e.g. if a value is to be send from cluster 1 to cluster 4, it can not be directly send within one cycle but at least two cycles are needed.

FIG. 5 shows a inter-cluster communication ICC scheme via a segmented bus according to a first embodiment. Said ICC scheme may be incorporated into a VLIW processor. The scheme comprises 4 clusters C1-C4 connected to each other via a bus 100 and one switch 200 segmenting the bus. When the switch 200 is open, one data move can be performed between cluster 1 C1 and cluster 2 C2 and/or another between cluster 3 C3 and cluster 4 C4 within one cycle. On the other hand, when the switch 200 is closed, data can be moved within one cycle from cluster 1 C1 or cluster 2 C2 to either cluster 3 C3 or cluster 4 C4.

With this scheme the scalability of the hardware resources, like the number of clusters and switches, is linear as in the case of known ICC as shown in FIG. 2.

Although the ICC scheme according to the first embodiment only shows a single bus 100, the principles of the invention can readily be applied to multi-bus ICC schemes as shown in FIG. 3 and ICC schemes using local busses as shown in FIG. 4. Merely some switches 200 need to be incorporated into the multi-bus or the local bus in order to achieve a split or segmented bus.

FIG. 6 shows a inter-cluster communication ICC scheme via a segmented bus according to a second embodiment. Here the clusters C1-C4 as well as the switch control is shown in more detail. Each cluster C1-C4 comprises a register file RF and a functional unit FU, and is connected to one bit bus 100 via an interface which is constituted of merely 3 OR gates G per bit. Alternatively, AND, NAND or NOR gates G can be used as interface. However, each cluster C1-C4 can obviously comprise more than one register file RF and one functional unit FU. The functional units FU may be specialised functional units FU dedicated to any bus opera tons. Furthermore, there may be several functional units writing to the bus.

The representation of the bypass logic of the register file is omitted, since it is not essential for the understanding of the split or segmented bus according to the invention. Although only one bit of the bus word is shown, it is obvious that the bus can have any desired word size. Moreover, the bus according to the second embodiment is implemented with two wires per bit. One wire is carrying the left to right value while the other wire carries the right to left value of the bus. However, other implementations of the bus are also possible.

The bus splitting switch can be implemented with just a few MOS transistors M1, M2 for each bus line.

The access control of the bus can be performed by the clusters C1-C4 by issuing a local_mov or a global_mov operation. The arguments of these operations are the source register and the target register. The local_mov operation merely uses a segment of the bus by opening the bus-splitting switch, while the global_mov uses the whole bus 100 by closing the bus-splitting switch 200.

Alternatively, in order to allow multicast, the operation to move data may accept more than one target register, i.e. a list of target registers, belonging to different clusters C1-C4. This may also be implemented by a register/cluster mask in a one bit vector.

FIG. 7 shows a inter-cluster communication ICC scheme via a segmented bus according to a third embodiment of the invention. FIG. 7 depicts six clusters C1-C6, a bus 100 with three segments 100a, 100b, 100c and two switches 200a, 200b, i.e. two clusters are associated to each bus segment. Obviously, the number of clusters, switches and bus segments may vary from this example The clusters C1-C6, the interface of the clusters and the bus 100 as well as the switches 200 can be embodied as described in the second embodiment with reference to FIG. 6. In the third embodiment the switches are considered to be closed by default.

The bus access can be performed by the clusters C1-C6 either by a send operation or a receive operation. In those cases that a cluster needs to send data, i.e. perform a data move, to another cluster via the bus, said cluster performs a send operation, wherein said send operation has two arguments, namely the source register and the sending direction, i.e. the direction to which the data is to be sent. The sending direction can be ‘left’ or ‘right’, and to provide for multicast it can also be ‘all’, i.e. ‘left’ and ‘right’.

For example, if cluster 3 C3 needs to move data to cluster 1 C1, it will issue a send operation with a source register, i.e. one of its registers where the data to be moved is stored, and a sending direction indicating the direction to which the data is to be moved as arguments. Here, the sending direction is left. Therefore, the switch 200b between cluster 4 C4 and cluster 5 C5 will be opened, since the bus segment 200b with the clusters 5 and 6 C5, C6 is not required for this data move. Or in other more general words, when the cluster issues a send operation, the switch, which is arranged closest on the opposite side of the sending direction, is opened, whereby the usage of the bus is limited to only those segments which are actually required to perform the data move, i.e. those segments between the sending and the receiving cluster.

If the cluster 3 C3 needs to send the same data to clusters 1 and 6 C1, C6, i.e. a multicast, then the sending direction will be ‘all’. Therefore, all switches 200a between the cluster 3 and the cluster 1 as well as all switches 200b between the clusters 3 and 6 will remain closed.

According to a further example, if cluster 3 C3 needs to receive data from cluster 1 C1, it will issue a receive operation with a destination register, i.e. one of its registers where the received data is to be stored, and a receiving direction indicating the direction from where the data is to be received as arguments. Here, the receiving direction is left. Therefore, the switch 200b between cluster 4 and cluster 5 C4, C5 will be opened, since the bus segment 100c with the clusters 5 and 6 C5, C6 is not required for this data move. Or in other more general words, when the cluster issues a receive operation, the switch, which is arranged closest on the opposite side of the receiving direction, is opened, whereby the usage of the bus is limited to only those segments which are actually required to perform the data move, i.e. those segments between the sending and the receiving cluster.

For the provision of multicast the receiving direction may also be unspecified. Therefore, all switches will remain closed.

According to a fourth embodiment, which is based on the third embodiment, the switches do not have any default state. Furthermore, a switch configuration word is provided for programming the switches 200. Said switch configuration word determines which switches 200 are open and which ones are closed. It may be issued in each cycle as with normal operation, like a sending/receiving operation. Therefore, the bus access is performed by a sending/receiving operation and a switch configuration word in contrast to a bus access by a sending/receiving operation with the sending/receiving direction as argument as described according to the third embodiment.

1. A clustered Instruction Level Parallelism processor, comprising:
a plurality of clusters each comprising at least one register file and at least one functional unit;
a bus means for connecting said clusters, said bus comprising a plurality of bus segments, and
switching means, arranged between adjacent bus segments, for connecting or disconnecting adjacent bus segments.

2. Processor according to claim 1, wherein each cluster is coupled to at least one bus segment.

3. Processor according to claim 1, wherein two or more clusters are coupled to the same bus segment.

4. Processor according to claim 1, wherein said bus means is a multi-bus comprising at least two busses.

5. Method for accessing a bus in a clustered Instruction Level Parallelism processor, wherein said bus comprises at least one switching means along said bus, comprising the steps of:
performing a sending operation based on a source register and a transfer word, and/or
performing a receiving operation based on a designation source register and a transfer word;
opening/closing said switching means according to said transfer word.

6. Method according to claim 5, wherein said transfer word represents the sending direction for the sending operation and the receiving direction for the receiving operation.

7. Method according to claim 6, wherein the default state of said switching means is closed.

8. Method according to claim 7, wherein the one of said switching means, which is closest to a cluster performing said sending operation or said receiving operation in the direction opposite of said sending or said receiving direction, is opened.

9. Method according to claim 6, wherein said sending direction or said receiving direction is left, right or all.

10. Method according to claim 9, wherein no switching means is opened, if said sending direction or receiving direction is all.

11. Method according to claim 5, wherein said transfer word represents a switch configuration word, wherein said switching means are opened or closed according to said configuration word.
